(19) United States
(12) Patent Application Publication
(10) Pub. No.: US 2024/0204354 A1
(43) Pub. Date: Jun. 20, 2024

(54) CELL SEPARATOR

(71) Applicant: Dyson Technology Limited, Wiltshire (GB)

(72) Inventors: Alex MADSEN, Swindon (GB); Matthew Robert ROBERTS, Oxford (GB); Daniel Stephen BOWES, Trowbridge (GB); Liyu JIN, Swindon (GB); Rimaz RAMEEZ, London (GB); Reza PAKZAD, Swindon (GB); Steven ROBSON, Bristol (GB)

(73) Assignee: Dyson Technology Limited, Wiltshire (GB)

(21) Appl. No.: 18/286,745

(22) PCT Filed: Mar. 22, 2022
(86) PCT No.: PCT/GB2022/050716

§ 371 Date: Oct. 12, 2023

(30) Foreign Application Priority Data
Apr. 15, 2021 (GB) 2105391.3

(51) Int. Cl. H01M 50/426; H01M 10/0525; H01M 50/406

(52) U.S. Cl. CPC H01M 50/426; H01M 10/0525; H01M 50/406

(57) ABSTRACT

A thermally manufactured separator for a cell and a method of making the same. The separator includes a polymer matrix and a plasticiser, and the separator is substantially free from electrolyte.

### TECHNICAL FIELD

The present invention relates to a thermally manufactured separator for a cell, a method of forming a lithium-ion cell including a separator, and a battery including the same.

### BACKGROUND

Lithium-ion cells with a gel electrolyte may include a free-standing polymer separator between electrodes.

US 2003/0157410A1 describes manufacture of a separator for use in such a gelled-electrolyte cell. The method of manufacture includes solvent casting and evaporation of gel electrolyte precursors. Producing a separator by dissolution of polymer into a solvent and subsequent evaporation increases processing cost and complexity.

EP 1320905A1 describes the manufacture of battery components by extrusion. Extrusion may be advantageous as there are no evaporation/phase inversion steps, reducing the processing required, and the overall cost. However, extrusion typically requires elevated processing temperatures (to achieve appropriate viscosity), and this limits the composition (since some components such as the polymer or electrolyte salt may decompose at elevated temperature).

### SUMMARY

According to a first aspect of the present invention, there is provided a thermally manufactured separator for a cell, the separator comprising a polymer matrix and a plasticiser, and wherein the separator is substantially free from electrolyte.

In some cases, the first aspect of the invention provides an extruded separator for a cell, the separator comprising a polymer matrix and a plasticiser, and wherein the separator is substantially free from electrolyte.

In some cases, the polymer matrix comprises one or more compounds selected from polyvinylidene fluoride, poly(vinylidene fluoride-co-hexafluoropropylene), poly(methyl methacrylate), polyethylene oxide, polyacrylonitrile, polyvinyl chloride, polytetrafluoroethylene, polyethylene, and polypropylene.

In some cases, the plasticiser comprises one or more compounds selected from ethylene carbonate, propylene carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone. In some such cases, the plasticiser comprises a carbonate.

A second aspect of the invention provides a method of forming a lithium-ion cell including a separator, the method comprising the steps of:
i) forming a separator comprising a polymer matrix and a plasticiser, and wherein the separator is substantially free from electrolyte; wherein during the forming step a composition comprising a polymer and the plasticiser, and which is substantially free from electrolyte, is heated to a temperature in excess of about 60° C.;
ii) contacting the separator with an electrolyte solution, such that electrolyte solution diffuses into the separator.

In some cases, the second aspect of the invention provides a method of forming a lithium-ion cell including a separator, the method comprising the steps of:
i) extruding a composition comprising a polymer and a plasticiser, and which is substantially free from electrolyte, to form a separator comprising a polymer matrix and the plasticiser, and wherein the separator is substantially free from electrolyte;
ii) contacting the separator with an electrolyte solution, such that electrolyte solution diffuses into the separator.

In some cases, during extrusion the composition is heated to at least 60° C., suitably at least 85° C.

In some cases, the electrolyte solution comprises a solvent, the solvent comprising one or more compounds selected from ethylene carbonate, propylene carbonate, dimethyl carbonate, diethylcarbonate, ethylmethyl carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone.

In some cases, the method further comprises disposing the separator between a cathode and an anode.

A third aspect of the invention provides a cell comprising an anode, a cathode and a separator between the anode and cathode, wherein the separator is formed by the method of the second aspect.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows the rate performance of cells including separators made according to the inventive method described herein.

### DETAILED DESCRIPTION

By “thermally manufactured”, it is meant that manufacturing process involves a heating step, which exceeds a temperature of about 60° ° C., suitably at least about 85° C. Examples of thermal manufacturing processes included within this term include hot-rolling, hot-pressing and extruding.

Lithium-ion cells with a gel electrolyte may employ a free-standing polymer separator. A suitable candidate polymer is polyvinylidene fluoride (PVDF). Further, manufacture of a polymer separator utilising thermal manufacturing, and by extrusion in particular, may be advantageous as it reduces processing steps and overall cost.

However, thermal processing of polymer materials is not straightforward, since elevated temperatures may result in degradation of the polymer or require the use of lower molecular weight/lower crystallinity polymers which may be less desirable for optimum separator performance. In particular, extrusion using melt processing is not straightforward since the material must form a melt of suitable viscosity to allow for extrusion of a continuous film. This typically involves elevated temperatures.

The inventors have found that through adding plasticiser to a composition alongside a polymer, the composition is more readily processed for manufacture into a separator and this addition facilitates manufacture at lower temperatures (typically 50-60° ° C. lower than temperatures that would be required in the absence of plasticiser). The electrolyte is not present on separator formation (e.g. during extrusion) and is subsequently added to the separator during cell construction. The absence of electrolyte during manufacture (e.g. during extrusion), according to the inventors' method, facilitates processing at elevated temperatures and does not compromise the low temperature cell performance. Separator membranes produced by this method are relatively stable, easing subsequent handling and processing into cells.

More specifically, the inventors have determined that a plasticiser may be added to the polymer to aid extrusion. Suitable solvents to use as plasticisers including solvents commonly used in liquid electrolytes in state-of-the-art standard lithium-ion cells. Using materials compatible with normal cell operation ensures the presence of plasticiser will not negatively impact on cell performance/stability. In some embodiments, the solvent used as a plasticiser has a boiling point in excess of 100° C. These solvents have high boiling points and so do not evaporate during processing and extrusion at elevated temperature. The plasticiser lowers the temperature required in order for the composition to be extrudable.

Furthermore, the inventors have determined that the thermal manufacture (e.g. extrusion) of the separator should occur substantially in the absence of electrolyte. The electrolyte can be added to the separator after the thermal manufacture (e.g. extrusion) process is complete. This means that the temperature stability of the electrolyte is not a limiting factor in the process, and the materials can be processed at elevated temperatures without compromise to low temperature cell performance. By way of comparison, extrusion with electrolyte present limits the maximum temperature that can be used (e.g. the inclusion of LiPF6 salt would limit processing to <80° C., due to thermal breakdown of the salt) and limits the electrolyte composition (as low boiling point electrolyte solvents such as dimethylcarbonate or diethylcarbonate, which improve low-temperature performance of the cell, could not be used). In other words, in the absence of electrolyte, the extrusion can be performed at higher temperatures than would be possible in the presence of electrolyte since electrolyte degradation is not of concern. This eases processing, reduces costs and allows the separator manufacture to be optimised to give the best cell performance.

Once the plasticised polymer film separator has been formed, cells may be produced through electrode stacking or lamination with an anode and cathode. Electrodes/separator are packaged, filled with carbonate-based electrolyte solution containing lithium-salt and vacuum sealed. In a pouch-cell format, cells are clamped and heated to allow diffusion of the salt containing solution into the separator layer, while the plasticiser will diffuse into the electrode structure. The lithium-ion concentration of the electrolyte can be modified to account for the dilution effect from the plasticiser, so that the resulting concentration throughout the cell results in optimum transport properties. By clamping this layer during heating, it will limit expansion of the separator layer and will result improve adhesion of the gel electrolyte separator to the anode and cathode following subsequent cooling.

In some cases, the polymer matrix comprises one or more compounds selected from polyvinylidene fluoride, poly(vinylidene fluoride-co-hexafluoropropylene), poly(methyl methacrylate), polyethylene oxide, polyacrylonitrile, polyvinyl chloride, polytetrafluoroethylene, polyethylene, and polypropylene.

In some cases, the plasticiser comprises one or more compounds selected from ethylene carbonate, propylene carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone. In some such cases, the plasticiser comprises a carbonate.

In some cases, the weight ratio of polymer to plasticiser is between about 2:1 and 1:4, and suitably between about 1:1 and 1:2. The polymer content must be sufficient for a gel to form, and a higher plasticiser content provides a gel with higher conductivity.

On formation (e.g. on extrusion), the composition is substantially free from electrolyte. By substantially free of electrolyte, it is meant that the composition comprises less than 5% by weight of electrolyte, suitably less than 3 wt %, 1 wt % or 0.1 wt %. In some cases, the composition does not comprise any electrolyte at all. In some cases, the composition is free from an electrolyte comprising one or more compounds selected from LiPF₆, lithium 2-trifluoromethyl-4,5-dicyanoimidazolide, lithium difluoro(oxalato)borate, lithium bis(fluorosulfonyl)imide and lithium tetrafluroborate.

In some cases, the separator is subsequently contacted with an electrolyte solution, such that electrolyte solution diffuses into the separator. In some such cases, the electrolyte solution comprises a solvent, the solvent comprising one or more compounds selected from ethylene carbonate, propylene carbonate, dimethyl carbonate, diethylcarbonate, ethylmethyl carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone. In some such cases, the electrolyte solution comprises one or more compounds selected from LiPF₆, lithium 2-trifluoromethyl-4,5-dicyanoimidazolide, lithium difluoro(oxalato)borate, lithium bis(fluorosulfonyl)imide and lithium tetrafluroborate.

In some cases, during extrusion the composition is heated to at least 60° C., suitably at least 85° C.

### Example

Two extruded separators, with the following compositions, were formed according to the method described below:

| | | | Polymer:Plasticiser |
|---|---|---|---|
| | Polymer | Plasticiser | (w/w) |
| Separator 1 | PVDF-HFP | EC/PC (3:1 w/w) | 1:1 |
| Separator 2 | PVDF-HFP | EC/PC (3:1 w/w) | 1:2 |

The polymer is a ultrahigh molecular weight poly(vinylidene fluoride-co-hexafluoropropylene), produced by Solvay.

The plasticiser was a 3:1 wt ratio blend of ethylene carbonate and propylene carbonate.

A mixture of the polymers and liquids described in the table are prepared in beaker or similar. This material is then manually fed into a twin screw extruder with shear mixing zones at a temperature of 120-140° ° C. After being passed through the twin screws the material is passed through a single screw region and into a die head which shapes the material to a thickness of the 50-100 μm and a width of around 10-20 cm. The single screw and die head maintain the temperature of the sample at 120-140° C. The material is fed onto a roller and wound into reel. The material can then be stored until further tests.

Electrochemical evaluations of the separators were carried out with Swagelok cells. All the cells have one layer of cathode with areal coating weight over 150 g/m², which consists of over 90 wt % a high nickel NMC active materials and one layer of anode with areal coating weight over 100 g/m², which consists of over graphite active materials.

Cell assembly was carried out in a dry-room with Dew point less than −40° C. By design, the nominal capacity was about 3.5 mAh. The capacity balance was controlled at about 85-90% utilisation of the anode. For all the cells, the gel separators were used and 70 μl of a conventional LiPF₆ electrolyte composition (with an ethylene carbonate and ethylmethyl carbonate solvent) was added.

All the cells were electrochemically formed at 30° C. A cell was initially charged with a current of C/20 (a current with which it takes 20 hours to fully charge or discharge the cell) for the first hour and then increased to C/10 for the rest of charging until the cell voltage reaching the cut-off voltage of 4.2V. Then the cell is discharged at C/10 until the cut-off voltage of 2.5V. The cell cycles two more cycles with the same cut-off voltages at C/10 for both charging and discharging. Once a cell passed this formation step, rate capability was tested at 30° ° C. The C-rates were calculated based on cathode nominal capacity (active material weight times its theoretical capacity). In a rate capability test, all the charging was carried out at current of C/5 while the discharging ranging from C/10 to 10 C. The rate capacities were thus determined, which can be further normalised by dividing the C/5 capacity from the same test.

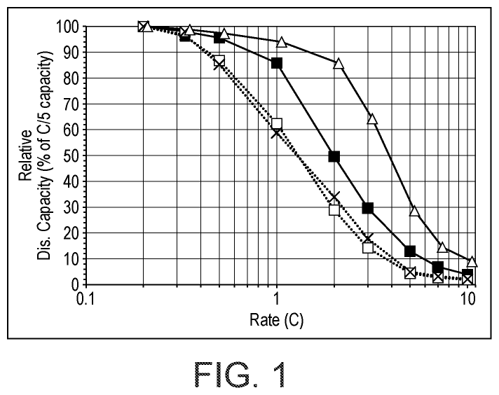

The results are shown in FIG. 1, where the dashed lines show results for separator 1 and the solid lines show results for separator 2. (Each test was run twice.) The cell including separator 2 demonstrated better rate performance; it is thought that this is likely due to higher conductivity in this gel separator.

For the avoidance of doubt, where in this specification the term “comprises” is used in defining the invention or features of the invention, embodiments are also disclosed in which the invention or feature can be defined using the terms “consists essentially of” or “consists of” in place of “comprises”.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1: A thermally manufactured separator for a cell, the separator comprising a polymer matrix and a plasticiser, and wherein the separator is substantially free from electrolyte.

2: An extruded separator for a cell, the separator comprising a polymer matrix and a plasticiser, and wherein the separator is substantially free from electrolyte.

3: The separator according to claim 1, wherein the polymer matrix comprises one or more compounds selected from polyvinylidene fluoride, poly(vinylidene fluoride-co-hexafluoropropylene), poly(methyl methacrylate), polyethylene oxide, polyacrylonitrile, polyvinyl chloride, polytetrafluoroethylene, polyethylene, and polypropylene.

4: The separator according to claim 1, wherein the plasticiser comprises one or more compounds selected from ethylene carbonate, propylene carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone.

5: The separator according to claim 4, wherein the plasticiser comprises a carbonate.

6: A method of forming a lithium-ion cell including a separator, the method comprising the steps of:
(i) forming a separator comprising a polymer matrix and a plasticiser, and wherein the separator is substantially free from electrolyte; wherein during the forming step a composition comprising a polymer and the plasticiser, and which is substantially free from electrolyte, is heated to a temperature in excess of about 60° C.;
(ii) contacting the separator with an electrolyte solution, such that electrolyte solution diffuses into the separator.

7: A method of forming a lithium-ion cell including a separator, the method comprising the steps of:
i) extruding a composition comprising a polymer and a plasticiser, and which is substantially free from electrolyte, to form a separator comprising a polymer matrix and the plasticiser, and wherein the separator is substantially free from electrolyte;
ii) contacting the separator with an electrolyte solution, such that electrolyte solution diffuses into the separator.

8: The method according to claim 7, wherein during extrusion the composition is heated to at least 85° C.

9: The method according to claim 7, wherein the electrolyte solution comprises a solvent, the solvent comprising one or more compounds selected from ethylene carbonate, propylene carbonate, dimethyl carbonate, diethylcarbonate, ethylmethyl carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone.

10: The method according to claim 7, further comprising disposing the separator between a cathode and an anode.

11: A cell comprising an anode, a cathode and a separator between the anode and cathode, wherein the separator is formed by the method of claim 7.

12: The separator according to claim 2, wherein the polymer matrix comprises one or more compounds selected from polyvinylidene fluoride, poly(vinylidene fluoride-co-hexafluoropropylene), poly(methyl methacrylate), polyethylene oxide, polyacrylonitrile, polyvinyl chloride, polytetrafluoroethylene, polyethylene, and polypropylene.

13: The separator according to claim 2, wherein the plasticiser comprises one or more compounds selected from ethylene carbonate, propylene carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone.

14: The separator according to claim 13, wherein the plasticiser comprises a carbonate.

15: The method according to claim 6, wherein the electrolyte solution comprises a solvent, the solvent comprising one or more compounds selected from ethylene carbonate, propylene carbonate, dimethyl carbonate, diethylcarbonate, ethylmethyl carbonate, gamma-butyrolactone, vinylene carbonate, fluoroethylene carbonate, trimethyl phosphate, sulfolane, tetraethylene glycol dimethyl ether, triethylene glycol dimethyl ether and ethylmethoxyethyl sulfone.

16: The method according to claim 6, further comprising disposing the separator between a cathode and an anode.

17: A cell comprising an anode, a cathode and a separator between the anode and cathode, wherein the separator is formed by the method of claim 6.
